(19) United States
(12) Patent Application Publication
(10) Pub. No.: US 2023/0011844 A1
(43) Pub. Date: Jan. 12, 2023

(54) Method for Producing Cellulose Nanofiber Carbon

(71) Applicant: Nippon Telegraph and Telephone Corporation, Tokyo (JP)

(72) Inventors: Hironobu Minowa, Musashino-shi, Tokyo (JP); Masaya Nohara, Musashino-shi, Tokyo (JP); Mikayo Iwata, Musashino-shi, Tokyo (JP); Hiroaki Taguchi, Musashino-shi, Tokyo (JP); Takeshi Komatsu, Musashino-shi, Tokyo (JP)

(21) Appl. No.: 17/778,288

(22) PCT Filed: Nov. 26, 2019
(86) PCT No.: PCT/JP2019/046141

§ 371 Date: May 19, 2022

(51) Int. Cl. D01F 9/16; C01B 32/05

(52) U.S. Cl. CPC D01F 9/16; C01B 32/05

(57) ABSTRACT

A method for producing cellulose nanofiber carbon includes a freezing step of freezing a solution or gel containing cellulose nanofibers to obtain a frozen product, a drying step of drying the frozen product in a vacuum to obtain a dried product, and a carbonizing step of heating and carbonizing the dried product in an atmosphere in which the dried product does not burn to obtain cellulose nanofiber carbon, in which, in the carbonizing step, the dried product is heated together with a sacrificial agent that is carbonized before the dried product is carbonized to generate a reducing gas.

### TECHNICAL FIELD

The present invention relates to a method for producing cellulose nanofiber carbon.

### BACKGROUND ART

Carbon nanofibers are fibrous and generally have an outer diameter of 5 to 100 nm and a fiber length equal to or more than 10 times the outer diameter. Due to their unique shape, they have features such as high conductivity and high specific surface area.

The existing method for producing carbon nanofibers include an electrode discharge method, a vapor phase growth method, and a laser method has been known (NPLs 1 and 2). Additionally, a method capable of mass producing carbon nanofibers includes a method of heat-treating cellulose derived from natural products to produce cellulose nanofiber carbon.

### CITATION LIST

### Non Patent Literature

NPL 1: S. Iijima et al. “Single-shell carbon nanotubes”, Nature, Vol. 363, 17 Jun. 1993.
NPL 2: J. Kong et al. “Chemical vapor deposition of methane for single-walled carbon nanotubes”, Chemical Physics Letters 292, 567-574, 1998.

### SUMMARY OF THE INVENTION

### Technical Problem

There is a problem of the yield of the carbon nanofiber produced by the existing production method decreasing during the heat treatment process.

In addition, when the cellulose nanofibers are heat-treated to obtain a carbon material, there is a problem of the cellulose nanofibers being agglomerated during drying and sintered during the heat treatment, resulting in a dense carbon material, making it difficult to have a large specific surface area, and further, mass loss occurs due to gas generation (2C+O2→2CO, C+O2→CO2).

The present invention has been made in view of these problems, and an object of the present invention is to provide a method for producing cellulose nanofiber carbon that can be produced in a high yield.

### Means for Solving the Problem

One aspect of the present invention is a method for producing cellulose nanofiber carbon includes a freezing step of freezing a solution or gel containing cellulose nanofibers to obtain a frozen product, a drying step of drying the frozen product in a vacuum to obtain a dried product, and a carbonizing step of heating and carbonizing the dried product in an atmosphere in which the dried product does not burn to obtain cellulose nanofiber carbon, in which, in the carbonizing step, the dried product is heated together with a sacrificial agent that is carbonized before the dried product is carbonized to generate a reducing gas.

### Effects of the Invention

The present invention provides a method for producing cellulose nanofiber carbon in a high yield.

### BRIEF DESCRIPTION OF DRAWINGS

FIG. 1 is a flowchart depicting a method for producing cellulose nanofiber carbon according to an embodiment.

FIG. 2 is a table of yields, specific surface areas, and porosities of Experimental Examples and Comparative Example.

### DESCRIPTION OF EMBODIMENTS

Embodiments of the present invention are described below with reference to the drawings.

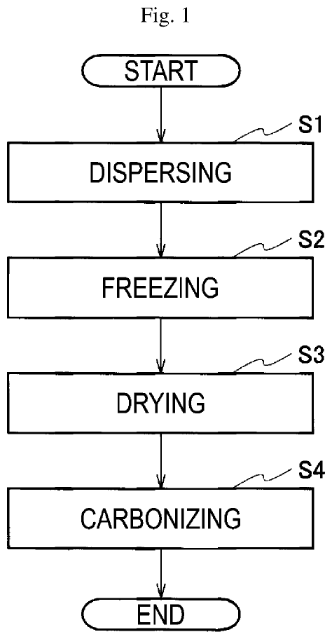

FIG. 1 is a flowchart depicting a method for producing cellulose nanofiber carbon according to an embodiment of the present invention. In the following description, the cellulose nanofiber carbon may also be referred to as a carbon material.

The method for producing cellulose nanofiber carbon of the present embodiment includes a dispersing step (step S1), a freezing step (step S2), a drying step (step S3), and a carbonizing step (step S4). This production method requires a solution or gel containing cellulose nanofibers. In the present embodiment, a solution containing cellulose nanofibers (hereinafter, referred to as a “cellulose nanofiber solution”) will be described below, but a gel containing cellulose nanofibers may be used.

The cellulose nanofibers having a fiber width (outer diameter) of about 3 nm and a fiber length of about 500 nm in the cellulose nanofiber solution are preferably dispersed. Therefore, the production process depicted in FIG. 1 includes a dispersing step (step S1), but the dispersing step (step S1) may be omitted. That is, when the cellulose nanofiber solution in which the cellulose nanofibers are dispersed is used, the dispersing step is unnecessary.

In the dispersing step, the cellulose nanofibers in the cellulose nanofiber solution are dispersed (step S1). The dispersion medium that can be used includes an aqueous medium such as water (H2O) or an organic medium such as carboxylic acid, methanol (CH3OH), ethanol (C2H5OH), propanol (C3H7OH), n-butanol, isobutanol, n-butylamine, dodecane, unsaturated fatty acid, ethylene glycol, heptane, hexadecane, isoamyl alcohol, octanol, isopropanol, acetone, or glycerin. Two or more of them may be mixed and used as the medium.

For dispersing the cellulose nanofibers, for example, a homogenizer, an ultrasonic cleaner, an ultrasonic homogenizer, a magnetic stirrer, a stirrer, or a shaker may be used.

The solid concentration of the cellulose nanofibers in the cellulose nanofiber solution is preferably from 0.001 to 80 mass %, and more preferably from 0.01 to 30 mass %.

In the freezing step, the cellulose nanofiber solution is frozen to obtain a frozen product (step S2). This step is performed by, for example, putting the cellulose nanofiber solution in an appropriate container such as a test tube, and freezing the cellulose nanofibers in the test tube by cooling the surroundings of the test tube in a coolant such as liquid nitrogen.

The freezing method is not particularly limited as long as the dispersion medium of the solution can be cooled to a temperature equal to or lower than the solidifying point, and the dispersion medium may be cooled in a freezer or the like. By freezing the cellulose nanofiber solution, the dispersion medium loses its fluidity, the dispersed cellulose nanofibers are fixed, and a three-dimensional network structure is constructed.

In the drying step, the frozen product frozen in the freezing step is dried in a vacuum to obtain a dried product (step S3). In this step, the frozen dispersion medium is sublimated from the solid state. For example, the step is performed by storing the obtained frozen product in an appropriate container such as a flask and vacuuming the inside of the container. By placing the frozen product in a vacuum atmosphere, the sublimation point of the dispersion medium decreases, so that even a substance that does not sublimate under normal pressure can be sublimated.

The degree of vacuum in the drying step varies depending on the dispersion medium to be used but is not particularly limited as long as the degree of vacuum is set such that the dispersion medium sublimates. For example, when water is used as the dispersion medium, it is necessary to set a degree of vacuum such that the pressure is 0.06 MPa or less, but it takes time to dry because heat is taken away as latent heat of sublimation. Therefore, the degree of vacuum is preferably 1.0×10−6 Pa to 1.0×10−2 Pa. Further, heat may be applied by using a heater or the like at the time of drying.

In the carbonizing step, the dried product dried in the drying step in an atmosphere in which the dried product does not burn to obtain cellulose nanofiber carbon (step S4). In the carbonizing step of the present embodiment, the dried product is heated together with a sacrificial agent. The sacrificial agent is a material (substance) that is carbonized before the cellulose nanofibers are carbonized and generates a reducing gas. Specifically, the sacrificial agent may be any material that consumes oxygen remaining in the atmosphere in the middle of the heating step by combustion (oxidation) reaction to generate a reducing gas (carbon dioxide).

Examples of the sacrificial agent include “pulp made from wood and plants”, “organic compounds such as hydrocarbons used for gas, liquid and solid fuels”, “metal powders that oxidize by combustion reaction, such as titanium, vanadium, chromium, iron, manganese, cobalt, nickel, copper, zinc, ruthenium, palladium, rhodium, lanthanum, rhenium, and silver”, “inorganic compounds such as alloys composed of one or more of the above-mentioned metal elements”, and two or more kinds thereof may be used in combination.

When pulp is used as a sacrificial agent, the amount of water absorption per unit volume of the pulp is preferably 85 L/m³ or more, and more preferably 150 L/m³ or more. The water absorption per unit weight of the pulp is preferably 5 L/kg or more, and more preferably 8 L/kg or more.

In the carbonizing step, the cellulose nanofibers (dried products) may be heated and carbonized together with a sacrificial agent. When a sacrificial agent that leaves a residue after heating is used, mixing of the carbonized cellulose nanofiber carbon and the residue of the sacrificial agent must be avoided. Therefore, it is desirable to place the sacrificial agent in isolation from the cellulose nanofibers so that the cellulose nanofibers and the sacrificial agent can be separated in the same atmosphere.

Carbonization of cellulose nanofibers may be carried out by firing at 200° C. to 2000° C., more preferably from 600° C. to 1800° C. in an inert gas atmosphere. The gas that does not burn cellulose nanofibers may be, for example, an inert gas such as nitrogen gas or argon gas. The gas that does not burn cellulose nanofibers may be a reducing gas such as hydrogen gas or carbon monoxide gas or may be carbon dioxide gas. Carbon dioxide gas or carbon monoxide gas, which has an activating effect on cellulose nanofiber carbon and can be expected to be highly activated, is more preferable.

In the carbonizing step of the present embodiment described above, the cellulose nanofibers are heated together with a sacrificial agent that is carbonized before the dried cellulose nanofibers (dried products) are carbonized to generate a reducing gas. As a result, in the present embodiment, when the cellulose nanofibers are heat-treated to obtain a carbon material, the specific surface area of the resulting carbon material is increased, and mass loss due to gas generation (2C+O2→2CO, C+O2→CO2) can be reduced. Therefore, the present embodiment allows the cellulose nanofiber carbon to be produced in a high yield.

According to the production method of the present embodiment, the cellulose nanofibers that are dispersed materials are fixed by the freezing step to construct a three-dimensional network structure. In addition, cellulose nanofibers with a three-dimensional network structure maintained are taken out by the drying step.

The cellulose nanofiber carbon prepared by the production method of the present embodiment is a stretchable carbon material having a three-dimensional structure of a co-continuum of interconnected cellulose nanofibers. Further, the cellulose nanofiber carbon of the present embodiment has high conductivity, corrosion resistance, and a high specific surface area.

Therefore, the cellulose nanofiber carbon produced by the production method of the present embodiment is suitable for the use in, for example, batteries, capacitors, fuel cells, biofuel cells, microbial batteries, catalysts, solar cells, semiconductor production processes, medical equipment, beauty equipment, filters, heat resistant materials, flame resistant materials, heat insulating materials, conductive materials, electromagnetic wave shielding materials, electromagnetic wave noise absorbing materials, heating elements, microwave heating elements, cone paper, clothes, carpets, mirror fogging prevention materials, sensors, and touch panels.

For the purpose of confirming the effect of the production method of the embodiment described above, an experiment of comparing the carbon materials produced by the production method of an embodiment of the present invention (Experimental Examples 1 to 5) with the carbon material produced without using a sacrificial agent in the carbonizing step in the embodiment (Comparative Example) was performed.

### Experimental Example 1

1 g of cellulose nanofibers having a fiber width of 3 to 4 nm and a fiber length of several hundred nm to 1 μm (manufactured by Nippon Paper Industries Co., Ltd.) and 10 g of ultrapure water were stirred with a homogenizer (manufactured by SMT Co., Ltd.) for 12 hours to prepare a dispersion of cellulose nanofibers, and the dispersion was poured into a test tube.

The cellulose nanofiber solution was completely frozen by immersing the test tube in liquid nitrogen for 30 minutes. After the cellulose nanofiber solution was completely frozen, the frozen cellulose nanofiber solution was taken out on a petri dish and dried in a vacuum of 10 Pa or less by a freeze dryer (manufactured by Tokyo Rikakikai Co., Ltd.) to obtain dried cellulose nanofibers.

After drying in a vacuum, the dried cellulose nanofibers were placed in an alumina crucible, the crucible was capped, 10 g of commercially available pulp tissue paper as a sacrificial agent was spread in the vicinity of it, and the cellulose nanofibers were carbonized by firing at 800° C. for 2 hours in a nitrogen atmosphere to prepare a carbon material (cellulose nanofiber carbon).

In the present experiment, 10 g of pulp tissue paper was allowed to absorb water so that the amount of water absorption per unit volume was about 88 L/m³, or the amount of water absorption per unit weight was about 5 L/kg. The amount of water absorption per unit volume and the amount of water absorption per unit weight represent the same amount of water absorption, and only their units are different.

In addition, in this experimental example, in order to avoid mixing of the carbon material and the residue of the sacrificial agent, the cellulose nanofiber and the sacrificial agent were placed separately in the same atmosphere in an alumina crucible.

### Experimental Example 2

In Experimental Example 2, a carbon material was produced in the same manner as in Experimental Example 1, except that the amount of water absorption per unit volume and per unit weight of pulp tissue paper as a sacrificial agent were 190 L/m³ and about 9 L/kg, respectively.

### Experimental Example 3

In Experimental Example 3, a carbon material was produced in the same manner as in Experimental Example 1, except that the amount of water absorption per unit volume and per unit weight of pulp tissue paper as a sacrificial agent were 225 L/m³ and about 12 L/kg, respectively.

### Experimental Example 4

In Experimental Example 4, a carbon material was produced in the same manner as in Experimental Example 1, except that the amount of water absorption per unit volume and per unit weight of pulp tissue paper as a sacrificial agent were 238 L/m³ and about 14 L/kg, respectively.

### Comparative Example

In Comparative Example 1, a carbon material was produced in the same manner as in Experimental Example 1, except that, in the carbonizing step, dried cellulose nanofibers were placed in an alumina crucible without using a sacrificial agent, and the cellulose nanofibers were carbonized by firing at 800° C. for 2 hours in a hydrogen atmosphere.

### Experimental Results

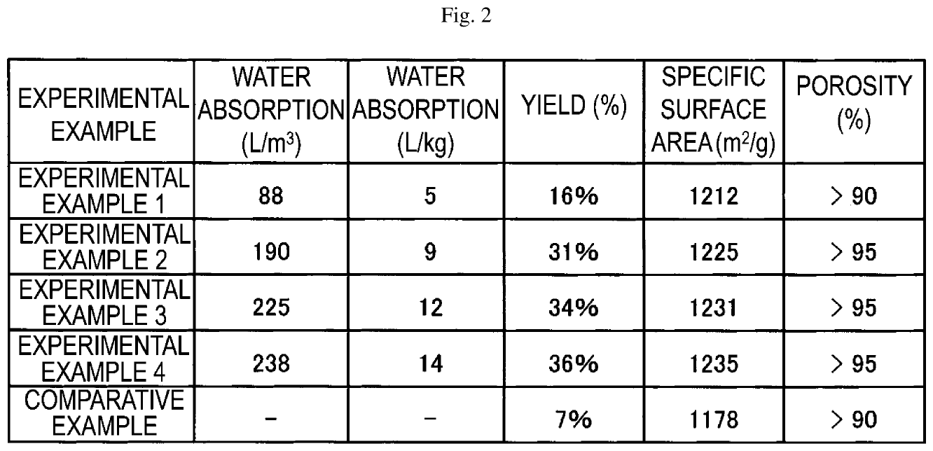

FIG. 2 shows experimental results of the carbon materials of the experimental examples and the comparative example. The table in FIG. 2 shows the yield, specific surface area, and porosity of the carbon materials of Experimental Examples 1 to 4 and Comparative Example. The yield is calculated by using the weight of the dried cellulose nanofiber before the heat treatment and the weight of the carbon material after the heat treatment. Specifically, the yield is a ratio between the weight of the dried cellulose nanofibers before the heat treatment and the weight of the carbon material after the heat treatment, and is calculated by the following equation:

Yield=weight of carbon material after heat treatment/weight of dried cellulose nanofibers before heat treatment×100[%]

The carbon materials of Experimental Examples 1 to 4 were not so different in specific surface area and porosity. Specifically, the specific surface areas in Experimental Examples 1 to 4 are from 1212 m²/g to 1235 m²/g. The porosity in Experimental Example 1 was more than 90%, and the porosity in Experimental Examples 2 to 4 was more than 95%.

The yield was improved as the amount of water absorption of the sacrificial agent was larger. This is considered to be because, although the properties of the obtained carbon material are hardly changed, the sacrificial agent consumes residual oxygen in the furnace in the process of carbonizing the carbon material, and carbon dioxide as a reducing gas is generated, so that gasification of cellulose nanofiber carbon is suppressed, resulting in the improvement in the yield of the carbon material (reaction formula: 2C+O2→2CO, C+O2→CO2).

This effect is considered to be obtained because a larger amount of water absorption allows the sacrificial agent to adsorb more residual oxygen to promote the generation of the reducing gas due to the combustion reaction of the sacrificial agent, resulting in a great effect.

From the results of Experimental Examples 1 to 4, the amount of water absorption per unit volume of pulp tissue paper (pulp) used as a sacrificial agent is preferably 85 L/m³ or more, and more preferably 150 L/m³ or more. The water absorption per unit weight of the pulp tissue paper is preferably 5 L/m³ or more, and more preferably 8 L/kg or more.

The yield of the carbon material of Comparative Example is smaller than that in Experimental Examples 1 to 4, and the specific surface area is also smaller than that in Experimental Examples 1 to 4.

The present invention is not limited to the above embodiment, and various modifications can be made within the scope of the gist of the present invention.

### REFERENCE SIGNS LIST

S1 Dispersing step
S2 Freezing step
S3 Drying step
S4 Carbonizing step

1. A method for producing cellulose nanofiber carbon, the method comprising:
freezing a solution or gel containing a cellulose nanofiber to obtain a frozen product;
drying the frozen product in a vacuum to obtain a dried product; and
heating and carbonizing the dried product in an atmosphere in which the dried product does not burn to obtain cellulose nanofiber carbon, wherein
in the carbonizing, the dried product is heated together with a sacrificial agent that is carbonized before the dried product is carbonized to generate a reducing gas.

2. The method for producing the cellulose nanofiber carbon according to claim 1, wherein pulp is used as the sacrificial agent.

3. The method for producing the cellulose nanofiber carbon according to claim 2, wherein an amount of water absorption per unit volume of the pulp is 150 L/m³ or more.

4. The method for producing the cellulose nanofiber carbon according to claim 2, wherein the amount of water absorption per unit volume of the pulp is 8 L/kg or more.

5. The method for producing the cellulose nanofiber carbon according to claim 3, wherein the amount of water absorption per unit volume of the pulp is 8 L/kg or more.
